(19) United States
(12) Patent Application Publication
(10) Pub. No.: US 2002/0163883 A1
(43) Pub. Date: Nov. 7, 2002

(54) Methods and systems for providing call admission control in packetized voice networks

(76) Inventor: Jeffrey M. Price, Del Mar, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/847,331

(22) Filed: May 3, 2001

(51) Int. Cl. H04J 1/16; H04L 12/28

(52) U.S. Cl. 370/229; 370/411; 370/468; 709/223; 709/229

(57) ABSTRACT

A method and system is disclosed for providing packetized voice (PV) call admission control (CaC), which delivers uninterrupted voice network services concurrently with data network services. Utilization of PV CaC prevents voice service interruption caused by congestion in PV networks, which can occur when the network has insufficient bandwidth resources to ensure the Quality of Service (QoS) of all calls. As the network's bandwidth capacity diminishes and approaches a predefined congestion onset threshold, an appropriate congestion indicator is “piggybacked” on the existing network service (or services) offered by the service provider. For PV, this piggybacked congestion notification will prevent additional calls from occurring by using a fast busy, or some other, signal to alert users (attempting to place a new call) that the service is unavailable to them. Upon the abatement of the diminished network capacity (i.e., a congestion threat no longer exists), the piggybacked congestion notification will be deasserted.

### BACKGROUND

1. Field of the Invention

This invention relates generally to providing packetized voice (PV) communications in networks offering concurrent voice and data services. More specifically, the invention relates to providing a call admission control (CaC) function to control congestion in services combining both voice and data communications.

2. Description of the Related Art

Current distributed networks that carry voice signals rely on analog lines and trunks as well as digital T1 circuits to connect subscribers, including, for example, small and medium-sized businesses (SMBs). Delivering voice and data to SMB customers usually requires multiple inefficient analog lines or expensive T1 lines or a combination of the two. New technologies can much more efficiently provide voice services using packetized voice (PV) techniques. Packetized voice refers generally to the process of carrying an analog voice call over packet-based networks. This can include the conversion of an analog voice call (between two or more users of a distributed network) into a digital representation contained in multiple packets of network information, transmission of that packetized voice signal to the appropriate recipients, and the conversion back into an analog voice signal at the customer premise equipment (CPE).

For example, the well-known digital subscriber line (DSL) technology can facilitate the transmission of voice over DSL (VoDSL). VoDSL offers an evolutionary path to more efficient and less expensive voice transmission by leveraging the existing voice infrastructure and enhancing core voice Time Division Multiplexing (TDM) switches with packet-based solutions. VoDSL inherently offers convergence, using a single physical connection to carry both voice and data transmissions. By comparison, current methods generally require the use of separate connections to deliver multiple voice lines and end-user data services.

Initial deployments of VoDSL may utilize centralized architectures, including, for example, Class 5 switches located at competitive local exchange carrier (CLEC) offices. Next-generation deployments of VoDSL may utilize the media gateway control protocol (MGCP). These MGCP-based solutions will fundamentally change VoDSL by enabling a distributed architecture that efficiently partitions network signaling and switching elements, making VoDSL more efficient to deploy, operate, scale, and manage.

VoDSL utilizes DSL technology, which provides a physical layer protocol for communicating information across a plain old telephone system (POTS) subscriber line at data rates exceeding those achievable using conventional analog modem technology and other physical layer protocols. One form of DSL is asymmetric digital subscriber line (ADSL) communication. ADSL communication involves transmitting data in one direction (typically towards the customer premises) at a greater data rate than data is transmitted in the other direction (typically towards the local exchange). There are also other known forms of DSL such as symmetric DSL (SDSL), high-speed DSL (HDSL) and very high-speed DSL (VDSL). These various forms of DSL are referred to generally herein as xDSL.

xDSL communication systems can be implemented using a digital subscriber loop access multiplexer (DSLAM) (or DSL concentrator) located at a central office or other local exchange termination point of the PSTN. A DSLAM typically contains a number of xDSL termination units, or modems, that can establish an xDSL link and communicate xDSL protocol data across POTS subscriber lines. The xDSL termination units can be connected to the POTS subscriber lines via splitter devices that separate the xDSL data traffic from voice traffic on the telephone lines. Because an xDSL modem operates at frequencies higher than the voice-band frequencies, use of a splitter enables an ADSL modem to operate simultaneously with a voice-band modem or a telephone conversation over the same subscriber line. A splitter is similarly used at the customer premises to separate voice and xDSL data traffic and to provide the xDSL data traffic to an xDSL termination unit located at the remote customer premises. Once established, the xDSL link allows high-speed data communication to occur between the local exchange and the customer premises equipment (CPE) located at a remote customer site in the communication system.

The CPE can include an xDSL interface component that has an xDSL termination unit for terminating the xDSL link, as well as a buffer or other interface component between the xDSL termination unit and other CPE components. The xDSL interface may be implemented, for example, in the form of a network interface card (NIC) that interfaces between the xDSL link and a bus on a personal computer, workstation or other computing device. The xDSL interface can also form a component of a network router or bridge, such as an Ethernet router or bridge.

The xDSL physical layer may support various types of higher-layer data and voice traffic. For example, data traffic may be carried in an asynchronous transfer mode (ATM) in which data ATM cells carry traffic. The xDSL physical layer may also support the transport of data traffic in a Frame Relay mode. In the Frame Relay mode data traffic is carried using frames formatted in accordance with the high-level data link control (HDLC) or other frame-based standard.

A Frame Relay network provides a user with multiple independent data links to one or more destinations. A Frame Relay network typically consists of a number of interconnected nodes, each of which are capable of receiving data from other nodes and forwarding that data through to yet other nodes. Nodes are interconnected by transmission paths, each of which supports one or more virtual circuits. Communication from one user to another can thus be made using the pre-defined network connections of the virtual circuits. The Frame Relay protocol is described generally in CCITT recommendation I.233, and recommendation Q.922 describes the associated Link Access Procedure for Frame-Mode Bearer Services (LAPF).

In a distributed communications network, a user of a network access device (such as an integrated access device (IAD)) that provides PV service may encounter congestion. This congestion, which is defined as a reduction (and, ultimately, a complete lack) of available capacity of network resources, can occur where the provider of the service oversubscribes that service. That is, the service provider allows more entities to subscribe to the service than can be adequately handled by the peak available capacity. Oversubscription is a common occurrence, since service providers base their prices and throughput on average use of the available capacity, not on the peak available capacity.

In the past, systems have been developed for specific technologies to handle congestion and to provide connection admission control in data networks. For example, Frame Relay networks utilize a Forward Explicit Congestion Notification (FECN) bit and Backward Explicit Congestion Notification (BECN) bit to indicate network congestion. Similarly, an Explicit Forward Congestion Indication (EFCI) bit indicates network congestion in ATM networks.

In each of the above cases, the congestion notification indicates congestion in the data network for a single protocol. To appropriately and cost effectively meet the needs of its end users, however, a service provider would benefit from being able to deliver multiple services using a single device. For example, it would be advantageous for the service provider to be able to (i) use a DSL concentrator to concurrently provide both voice and data permanent virtual connections (PVCs) over Frame Relay, (ii) aggregate several DSL subscribers over a single PVC to provide Internet access, and (iii) provide PVCs over ATM. When provisioning concurrent PV and data services, however, the handling of congestion becomes a critical function. Without proper handling of congestion in the provisioning of PV services, users could be subject to conditions that resemble a complete outage of service (e.g., no dial tone) resulting from the lack of capacity in the communications network. Consequently, a need exists for a call admission control (CaC) system for PV that gracefully handles congestion. In particular, a method is needed for allowing a service provider to indicate the approach of congestion to CPE IADs that utilize concurrent services so that an actual congestion condition does not arise.

### SUMMARY OF THE INVENTION

In accordance with the methods and systems of this invention, a provider of packetized voice (PV) can detect and help prevent congestion in a distributed network, independent of the underlying protocol in the local network that provides the PV capability to the end subscriber. The method can include detection of the approach of congestion and appropriate handling of additional attempted PV communications. Once the approach of congestion is detected in the distributed network, a congestion indicator can be “piggy backed” the packets of the local network containing the integrated access devices (IADs) that provide combined voice and data services.

In an embodiment, a data transfer device can be used by a service provider to combine voice and data services, and to provide both voice and data services to subscribers via xDSL. The voice traffic, known generally as voice over DSL (VoDSL) in an xDSL system, can be carried by any packet-based protocol, including PV protocols such as voice over IP (VoIP), voice and media over ATM (VoATM), and voice over Frame Relay (VoFR). The data transfer device can detect the approach of congestion in the distributed network and assert a designated bit within the protocol of the LAN (including, for example, the FECN or BECN bit for VoFR, the EFCI bit for VoATM, or the TOS(x) bit for VoIP).

In another embodiment, a method according to the present invention can prevent additional calls from being made by a user of an IAD. Upon detection of congestion in the distributed network, the service provider can indicate the approach of congestion in the distributed network and can assert the appropriate indicator in the PV protocol being used by the local network. Upon detection of the assertion of the indicator of congestion, the IAD can respond by preventing a PV call from being made. When a user of such an IAD attempts to place a PV call, a particular tone (e.g., a “fast busy” tone) can be used to indicate that the call cannot be made.

### BRIEF DESCRIPTION OF THE DRAWINGS

FIG. 1 is a network diagram showing a network access provider using an embodiment of present invention.

FIG. 2 provides additional detail of the network access provider shown in FIG. 1.

FIG. 3 is a block diagram showing an integrated access device according to the present

FIG. 4 depicts the details of a data transfer device according to the present invention.

FIG. 5 depicts another network implementation of the present invention.

### DETAILED DESCRIPTION

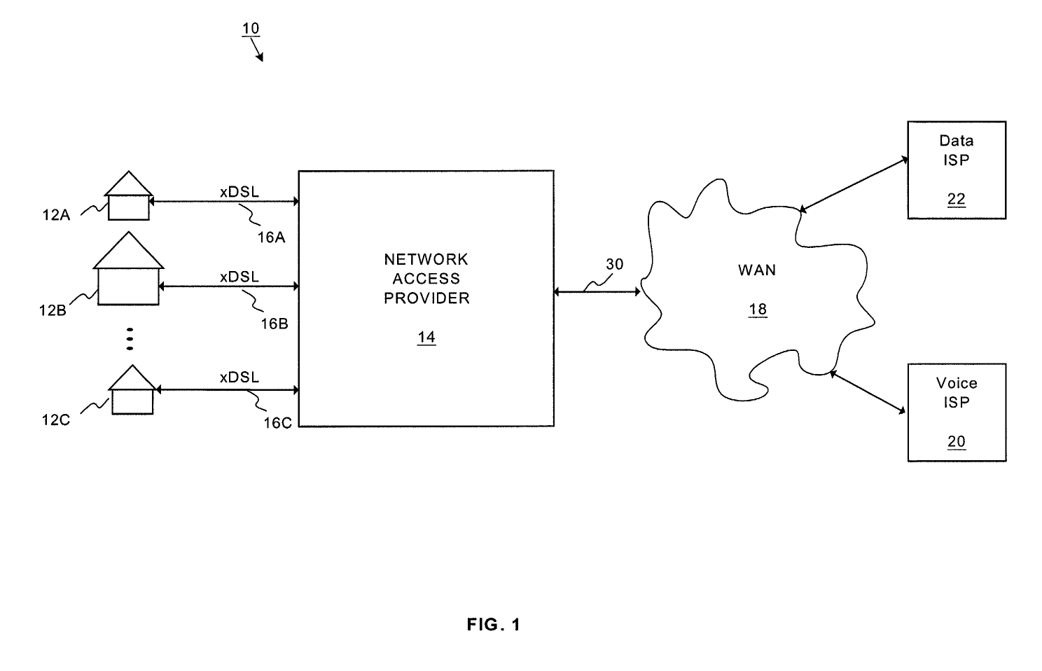

FIG. 1 is a block diagram of a telecommunications system 10 that can include the method of providing CaC according to the present invention. In an embodiment, a plurality of subscriber locations 12 can be connected to network access provider (NAP) 14 over a corresponding plurality of telecommunications links 16. NAP 14, via a wide area network (WAN) 18, can be in communication with an Internet service provider handling voice traffic (Voice ISP 20) and an Internet service provider handling data traffic (Data ISP 22). The WAN 18 may be implemented as, for example, an ATM network, a Frame Relay network, or an Internet Protocol (IP) network.

NAP 14 represents an entity that (i) terminates xDSL telecommunications link 16 at a central office or other local exchange termination point, and (ii) provides access to higher-level voice and data services respectively offered by the Voice ISP 20 and the Data ISP 22. It should be understood that NAP 14, Voice ISP 20, and Data ISP 22 may or may not be affiliated or under common control. For example, a regional Bell operating company (RBOC) could provide both xDSL service and data-based Internet access, in which case it would maintain the role of both NAP 14 and Data ISP 22. In operation, the NAP 14 receives frames of voice and data information from the xDSL telecommunications links 16. The NAP 14 forwards information from the received frames to the WAN 18, which delivers such information as appropriate to the Voice ISP 20 or the Data ISP 22. It should be clear that data transfer occurs in the reverse direction from the Voice ISP 20 and Data ISP 22 via the WAN 18 and the NAP 14. In this way the system 10 transports frames of voice and data information between the subscriber locations 12 and the Voice ISP 20 and Data ISP 22.

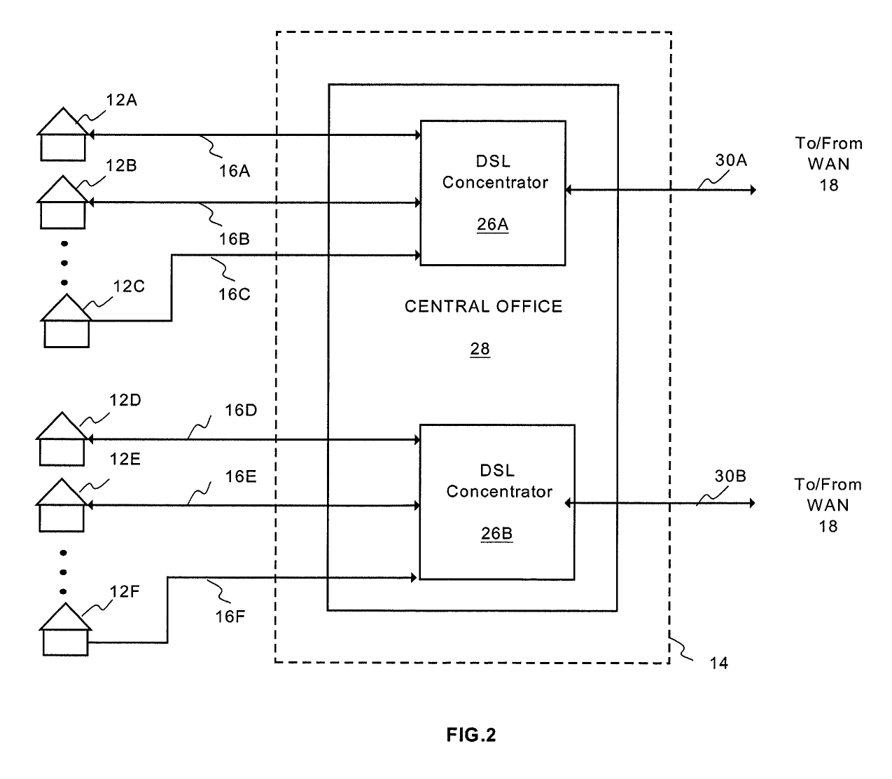

FIG. 2 illustrates a configuration of equipment that can be utilized by the NAP 14. The NAP 14 can provide its services using various data transfer devices. For example, as shown in FIG. 2, the NAP 14 may utilize one or more DSL concentrators 26 (one type of data transfer device) located at a central office 28 or other facility positioned near enough subscriber locations 12 to enable xDSL transmission to be effected over xDSL telecommunications links 16. Each DSL concentrator 26 is designed to support high-bandwidth applications over existing subscriber lines (i.e., the xDSL telecommunications links 16). In operation, each DSL concentrator 26 performs adaptation between the xDSL telecommunications links 16 and the WAN 18. In the downstream direction (i.e., towards the subscriber locations 12), each DSL concentrator 26 may perform routing and demultiplexing of framed data packets or ATM cells received from the WAN 18 over high-speed line 30. In the upstream direction (i.e., towards the WAN 18), each DSL concentrator 26 may perform multiplexing and concentration of framed data packets received over the xDSL telecommunications links 16 for transmission on high-speed line 30. Each DSL concentrator 26 may be implemented using, for example, a CopperEdge® 200 DSL Concentrator available from Copper Mountain Networks, Inc. of Palo Alto, Calif.

In an embodiment of the present invention, DSL concentrator 26A can be used to provide a permanent virtual connection (PVC) to a user of the network at a subscriber location 12. In this embodiment, a voice and data user at subscriber location 12 could place a voice call using PV over the local protocol, which could be Frame Relay, IP or ATM. The user at subscriber location 12 might, for example, place a voice call to another person located in a remote facility. To do so, for example, PV information from a user located at subscriber location 12A could travel from the IAD at subscriber location 12A through DSL concentrator 26A over high-speed line 30A to WAN 18, where the PV data would then be routed through the Internet to the remote user.

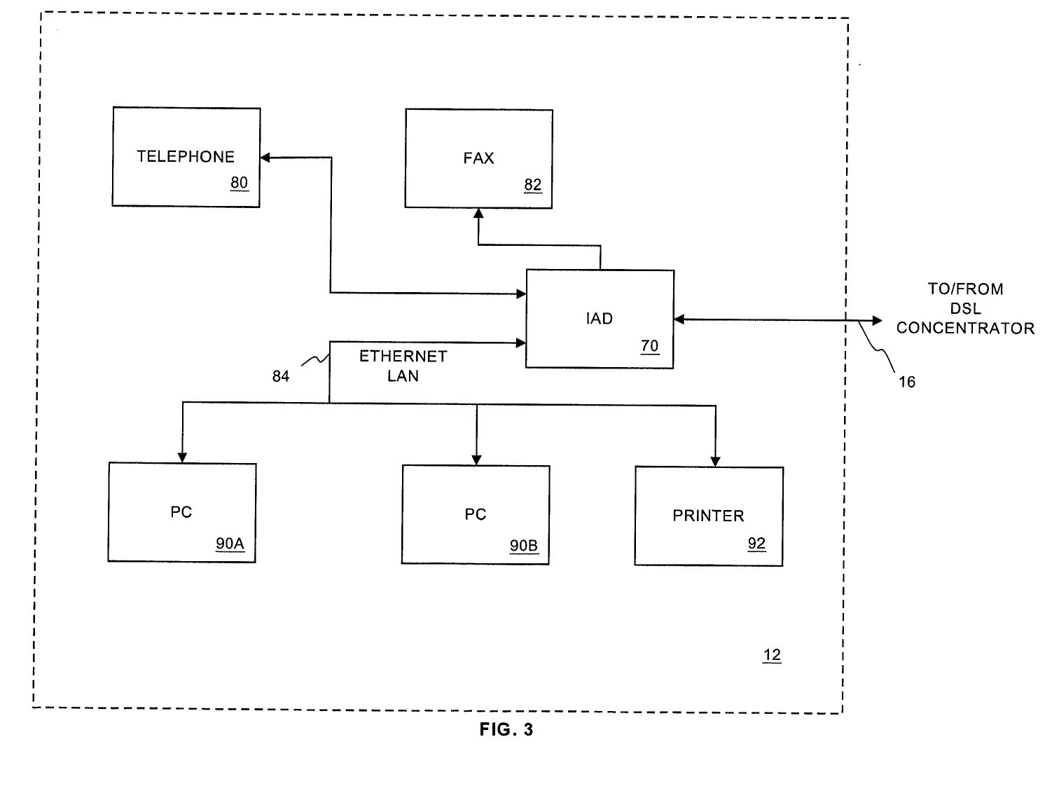

FIG. 3 illustrates a typical manner in which a network access device, such as xDSL integrated access device (IAD) 70, may be configured within a subscriber location 12. The IAD 70 facilitates voice and data communication between one or more users at a subscriber location 12 and the Voice ISP 20 and the Data ISP 22. As shown, the IAD 70 can interface with telephone devices such as a telephone 80 and fax machine 82, as well as with an access network, including, for example, an Ethernet local area network (LAN) 84. The subscriber location 12 may also include computers 90A, 90B and a laser printer 92 connected to the Ethernet LAN 84. In operation, the IAD 70 receives voice and data traffic from the telephone devices 80, 82 and the Ethernet LAN 84. In the reverse direction, data packets framed in the appropriate format are received from the DSL concentrator 26 over xDSL telecommunications link 16 and routed to the applicable telephone device 80, 82 or to the Ethernet LAN 84. The IAD 70 may be implemented using, for example, a CopperRocket® 408 SDSL Integrated Access Device available from Copper Mountain Networks, Inc. of Palo Alto, Calif.

During times when congestion exists in the network, in order to preserve the designated Quality of Service (QoS) for existing calls, a user of an integrated access device (IAD) may need to be gracefully prohibited from attempting to place a PV call. The Frame Relay Forward Explicit Congestion Notification (FECN) bit or Backward Explicit Congestion Notification (BECN) bit (collectively the xECN bit), and the ATM Explicit Forward Congestion Indication (EFCI) bit, if set, can be used to notify a receiving entity that the network is approaching a congested state. These can be used to prevent congestion from occurring and will allow any existing congestion to dissipate. Similarly, a predetermined bit within the IP Type of Service (ToS) byte could be used to notify the receiving entity that the sending entity is congested. This predetermined bit within the ToS byte of an IP packet can be used to perform a function similar to the Frame Relay xECN bit or the ATM EFCI bit; that is, it can be used to provide a signal to an IAD that will cause a fast busy/no-resource cause-code to the user, hence preventing the call from occurring.

Specifically, when an additional, or possibly initial (for aggregated IADS) POTS line goes off-hook, the DSL concentrator can detect the approach of congestion, assert the appropriate bit, and transmit subsequent packets with the asserted bit to the IAD. The IAD will receive the asserted bit as a notification of the approach of congestion and, until that notification is reset (i.e., the IAD receives an indication that the network is no longer approaching congestion), a fast busy/no-resource cause-code may be sent to the user, hence preventing the call from occurring.

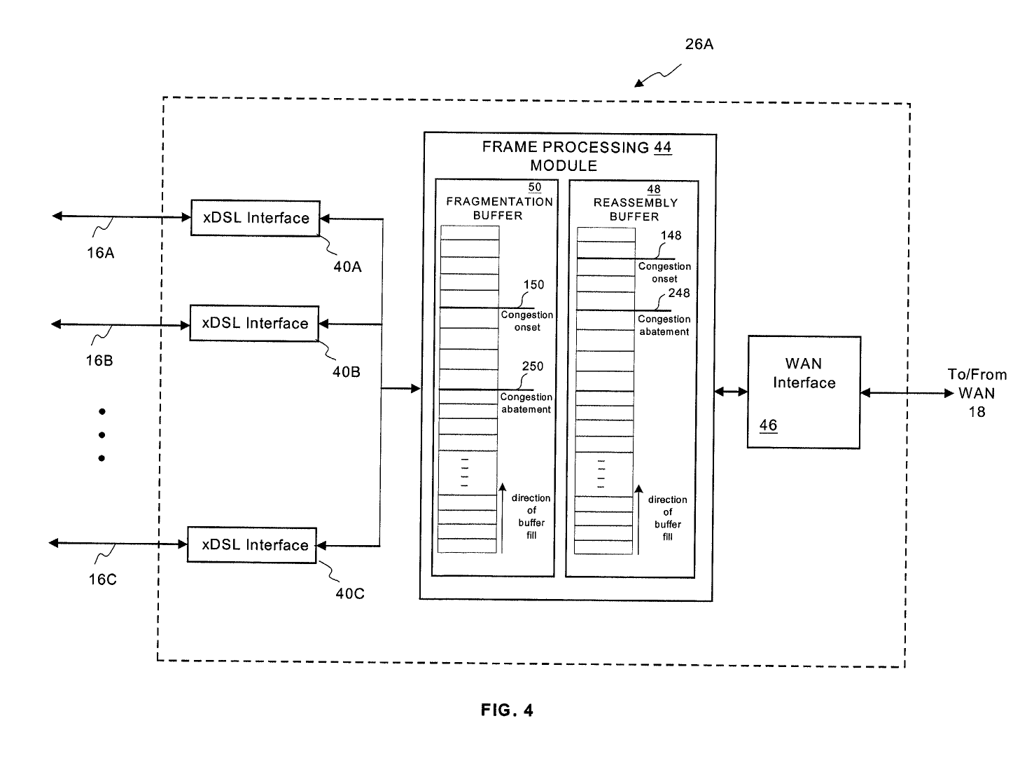

FIG. 4 provides a more detailed representation of a DSL concentrator 26A that can provide packetized voice call admission control in accordance with the present invention. The DSL concentrator 26A can include several xDSL interfaces 40, each of which defines a port for receiving an xDSL telecommunications link 16. Each xDSL interface 40 provides an endpoint for the xDSL physical layer between the DSL concentrator 26A and an associated subscriber location 12, and manages this physical layer by performing xDSL modulation/demodulation in accordance with any one of several formats known to those skilled in the art. The xDSL physical layer provides a point-to-point physical layer bitstream upon which any of various framed-packet data formats can be carried in the data link layer.

The WAN 18 will typically comprise a conventional wide area network operative in accordance with either the Frame Relay, ATM or IP protocols. When the WAN 18 is implemented as an ATM network, the WAN interface 46 can perform the upstream and downstream switching of ATM cell traffic on, for example, on a virtual channel identifier basis to and from the Voice ISP 20 and Data ISP 22. In this context the WAN interface 46 will typically (i) interface with ATM network elements such as ATM switches, ATM concentrators, and/or ATM routers, and (ii) establish and configure virtual circuits (VCs) in accordance with standard ATM traffic parameters. Establishment of such VCs enables the WAN interface 46 to map prioritized voice paths carried over the xDSL telecommunications links 16 to real-time VCs on an ATM-based WAN 18. When the WAN 18 is implemented as a Frame Relay or IP network, the WAN interface 46 may be similarly configured to manage the communication with the Voice ISP 20 and Data ISP 22 via framed data packets.

Various network resources can be associated with a measurement of congestion (MOC). The buffers used for temporary storage of PV data (such as buffers 48 and 50 shown in FIG. 4) are one example of such a network resource. In terms of buffer usage, congestion can be further defined as a relative shortage of capacity of these buffers. As another example, the analysis of congestion can be focussed on the link resource, which is the upstream WAN bandwidth that is used for real time variable bit rate (VBR) connections.

As shown in FIG. 4, a concentrator 26A in an embodiment of the present invention that provides a combination of voice and data services can contain a reassembly buffer 48 and a fragmentation buffer 50 that consist of dynamic random access memory (DRAM) or static random access memory (SRAM). Buffers 48 and 50 can be used to buffer data in temporary storage that is indexed relative to the port of concentrator 26A on which the data arrived and the destination port. If buffers 48 and 50 fill up, data will potentially get lost. In the context of PV, this could mean gaps in conversations or completely dropped calls.

To control congestion, the physical ports of concentrator 26A can be configured to allow a user to specify an associated Congestion Onset (CO) threshold and Congestion Abatement (CA) threshold for each port. As shown in FIG. 4, congestion onset thresholds 148 and 248, and congestion abatement thresholds 150 and 250 can be respectively configured to measure the extent to which buffers 48 and 50 have been filled or utilized. This enables determination of congestion is present or imminent on the associated port. In addition, oversubscription can be included using any desired oversubscription factor. An oversubscription factor can provide a measurement of the amount by which a network can have an overall user community that is greater than 100% of the available capacity of the network. This can be used to maximize the utilization of the network at any particular moment in time. In addition, a hysterysis mechanism could be introduced to smooth the reaction of the system as it settles near either of the thresholds.

As depicted in FIG. 4, fragmentation buffer 50 and reassembly buffer 48 can be filled from a relative location considered to be the bottom of the buffer up toward the top of the buffer. According to the invention, as fragmentation buffer 50 fills beyond congestion onset 150 or reassembly buffer 48 fills beyond congestion onset 148, the appropriate bit can be asserted in the data packets being sent via xDSL interface 40 through telecommunications links 16 to the end users, thereby preventing any further PV calls from being placed. Similarly, as fragmentation buffer 50 is being emptied beyond congestion abatement 250 or reassembly buffer 48 empties beyond congestion abatement 248, the appropriate bit can be deasserted in the data packets.

In an alternative embodiment, a link resource can be used as a measure of congestion, upon which decisions can be made about assertion and deassertion of the appropriate bit to indicate the approach or abatement of congestion. Whereas the preceding embodiment focuses on the buffers associated with each PVC, utilization of the link resource as a measure of congestion focuses on the total bandwidth available versus the aggregate usage by all subscribers. Referring again to FIG. 4, utilization of the link resource could involve measuring the aggregate bandwidth by all subscribers over each telecommunication link 16. This total could then be compared to the overall bandwidth available over WAN 18. As the aggregate usage by all subscribers increases and approaches the overall bandwidth available over WAN 18, the appropriate bit can be asserted in the data packets being sent via xDSL interface 40 through telecommunications links 16 to the end users, thereby preventing any further PV calls from being placed. Similarly, as the aggregate usage by all subscribers decreases, the appropriate bit can be deasserted in the data packets.

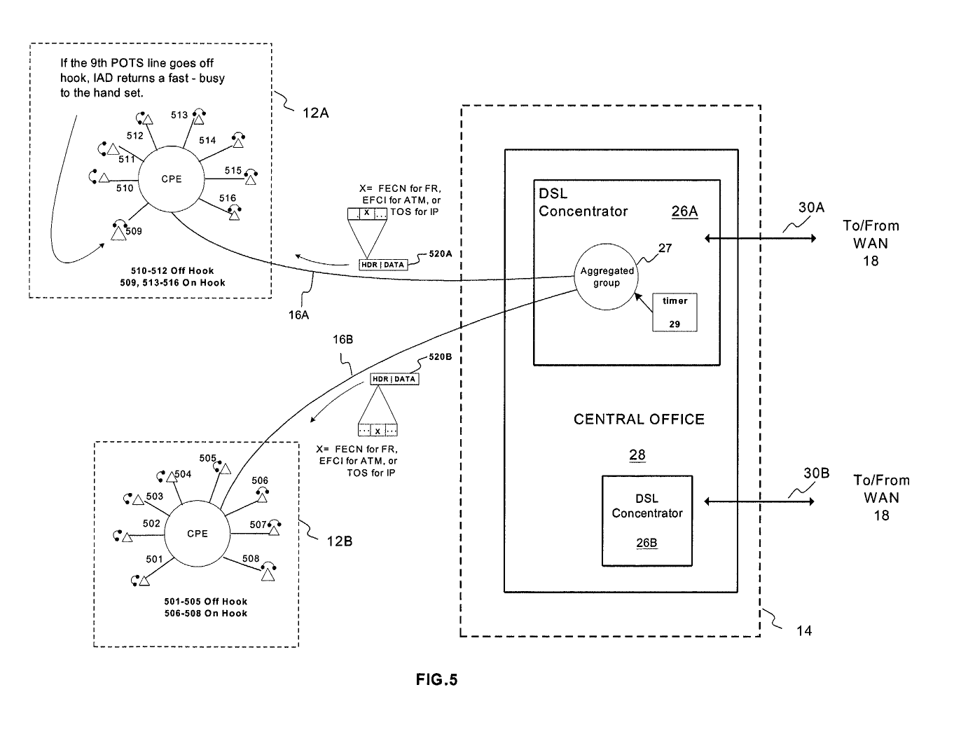

FIG. 5 shows an embodiment of the present invention in an aggregated network configuration with more than one DSL port in aggregated group 27 in which DSL concentrator 26A can be configured to control the approach of congestion in the WAN 18 according to the present invention. For example, at subscriber location 12A, IADs 510, 511, and 512 could be off hook, while IADs 509, 513, 514, 515, and 516 could be on hook. Similarly, at subscriber location 12B, IADs 501, 502, 503, 504, and 505 could be off hook, while IADs 506, 507, and 508, could be on hook. Upon detecting the approach of congestion, DSL concentrator 26A can set the appropriate bit in packets 520A and 520B (and subsequent packets over telecommunications links 16A and 16B) so that no further voice calls can be made. If, for example, IAD 509 were to be taken off-hook, it would detect the asserted congestion notification bit in packet 520A and return a fast-busy tone to the handset, thus preventing another POTS call from being made and thereby not increasing congestion.

Furthermore in such a system, once the congestion bit is asserted, during periods when there is no PV traffic to an IAD on a DSL port, timer 29 can be used to reset this congestion bit when congestion abates. When timer 29 expires and the WAN 18 is in a condition where congestion is approaching, DSL concentrator 26A can send dummy messages to the idle IADs, after setting an appropriate congestion control bit that disallows the first call to be made. This is necessary because not everyone uses the phones at the same time, and some IADs may have zero POTS lines off-hook.

When DSL concentrator 26A determines that a congestion abatement threshold (CA) associated with a particular port has been crossed because the traffic has subsided (i.e., some of the existing calls went on-hook), the congestion notification can be de-asserted in the traffic associated with that port from DSL concentrator 26A to the IADs at subscriber locations 12A and 12B.

While the invention has been described in detail, including references to specific embodiments, it will be apparent to one skilled in the art that changes and modifications can be made to the invention without departing from the spirit and scope thereof. Thus, it is intended that the present invention cover the modifications and variations of this invention provided they come within the scope of the appended claims and their equivalents. In particular, while the specific embodiment described above involves IP, Frame Relay, and ATM, an equivalent approach could be taken for Dynamic Synchronous Transfer Mode (DTM), or any other protocol that provides packetized voice over networks providing combined voice and data services.

What is claimed is:

1. A method for controlling establishment of a communication channel in a distributed network environment, comprising:
detecting approach of network congestion in said distributed network environment;
transmitting an indicator of said approach of congestion to a network access device;
receiving, at said network access device, said indicator;
preventing, in response to said indicator being asserted, said network access device from initiating establishment of a communication channel through said distributed network;
generating, at said network access device, a signal indicative of said congestion in response to said indicator;
deasserting said indicator upon the abatement of said approach of network congestion; and
terminating, at said network access device, said signal indicative of said congestion in response to said indicator.

2. A method as in claim 1, wherein said communications channel further comprises a packetized voice call.

3. A method as in claim 1, wherein said detecting further comprises monitoring capacity of said network.

4. A method as in claim 3, wherein said monitoring further comprises:
comparing the level of network usage against a congestion onset threshold;
asserting a congestion indication upon said congestion onset threshold being reached;
comparing the level of network usage against a congestion abatement threshold; and
deasserting said congestion indication upon said congestion abatement threshold being reached.

5. A method as in claim 4, wherein said comparing further comprises measuring the level of utilization of at least one data buffer against a congestion onset threshold.

6. A method as in claim 5, wherein said at least one data buffer comprises a reassembly buffer.

7. A method as in claim 5, wherein said at least one data buffer comprises a fragmentation buffer.

8. A method as in claim 4, wherein said comparing further comprises measuring aggregate bandwidth usage against a congestion onset threshold.

9. A method as in claim 4, wherein said asserting further comprises setting of the xECN bit in a Frame Relay environment.

10. A method as in claim 4, wherein said asserting further comprises setting of the EFCI bit in an asynchronous transmission mode environment.

11. A method as in claim 4, wherein said asserting further comprises setting of a predetermined bit in the TOS byte in an Internet Protocol environment.

12. A method as in claim 1, wherein said transmitting further comprises:
setting a timer to monitor usage of said communication channel;
determining, based on expiration of said timer, nonuse of said network access device; and
sending spurious messages to said nonused network access device to prevent initial establishment of a communication channel through said distributed network.

13. A method as in claim 1, wherein said generating further comprises causing a fast busy tone at said network access device.

14. A method for controlling establishment of a communication channel in a distributed network environment, comprising:
detecting approach of network congestion in a first network;
transmitting an indicator of said approach of network congestion in an access network in operative communication with said first network; and
deasserting said congestion indicator upon abatement of said approach of network congestion.

15. A method as in claim 14, wherein said indicator of said congestion is based on the network protocol of said access network.

16. A method for preventing call initiation by an integrated access device, comprising:
receiving a congestion indicator appropriate for said integrated access device from a data transfer device;
detecting an attempt to initiate a call by a user of said integrated access device during periods of approach of network congestion in a distributed network environment; and
providing an indication to said user of said integrated access device of the unavailability of the requested service.

17. A method as in claim 16, wherein said data transfer device further comprises a DSL concentrator.

18. A method as in claim 16, wherein said detecting further comprises a call initiation using the Voice over Asynchronous Transmission Mode (VoATM) technique.

19. A method as in claim 16, wherein said detecting further comprises a call initiation using the Voice over Internet Protocol (VoIP) technique.

20. A method as in claim 16, wherein said detecting further comprises a call initiation using the Voice over Frame Relay (VoFR) technique.

21. A method as in claim 18, wherein said receiving further comprises receiving an asserted EFCI bit.

22. A method as in claim 17, wherein said receiving further comprises receiving an asserted bit in the TOS byte.

23. A method as in claim 20, wherein said receiving further comprises receiving an asserted xECN bit.

24. A system for providing call admission control in a distributed network environment, comprising:
a data transfer device operably coupled to one or more computers in said distributed network environment, said data transfer device including software executable on a first of said one or more computers and configured to:
monitor network capacity;
detect onset of network congestion;
indicate said network congestion upon said network capacity exceeding a specified threshold by asserting a congestion indicator appropriate for an underlying network protocol; and
deassert said congestion indicator upon the abatement of said network congestion.

25. A system as in claim 24, wherein said data transfer device further comprises a DSL concentrator.

26. A computer readable medium containing computer program instructions for providing call admission control in a distributed network environment, said computer program containing instructions for:
monitoring network capacity;
detecting approach of network congestion;
indicating said approach of network congestion upon said network capacity exceeding a specified threshold by asserting a congestion indicator appropriate for the underlying network protocol; and
deasserting said congestion indicator upon the abatement of said approach of network congestion.
